(19) United States
(12) Patent Application Publication
(10) Pub. No.: US 2016/0350514 A1
(43) Pub. Date: Dec. 1, 2016

(54) METHOD AND SYSTEM FOR CAPTURING FOOD CONSUMPTION INFORMATION OF A USER

(71) Applicant: Samsung Electronics Co., Ltd., Suwon-si, Gyeonggi-do (KR)

(72) Inventors: Gandhi Gurunathan RAJENDRAN, Bangalore (IN); Subramanian RAMAKRISHNAN, Bangalore (IN)

(21) Appl. No.: 15/038,333

(22) PCT Filed: Dec. 5, 2014
(86) PCT No.: PCT/KR2014/011972

§ 371 Date: May 20, 2016

(30) Foreign Application Priority Data
Dec. 16, 2013 (IN) 5637/CHE/2013

(51) Int. Cl. G06F 19/00

(52) U.S. Cl. CPC G06F 19/3475; G06F 19/322

(57) ABSTRACT

A method and system for capturing food consumption information of a user is provided. The method includes automatically triggering one or more input means to capture information relating to the food being consumed by the user. The input means can be automatically triggered by detecting one or more food consumption actions of the user. In an embodiment, the input means can be, but not limited to an imaging member, a voice input means, a scanning member. The imaging member can be associated with user's articles such as wrist watch, ring, spectacles, mug, and so on. Further, the method includes generating one or more recommendations relating to the captured food information. Furthermore, the method includes providing the generated recommendations to the user and/or to a guardian of the user.

### TECHNICAL FIELD

The embodiments herein relate to diet monitoring systems and more particularly to a personalized diet monitoring system of a user. The present application is based on, and claims priority from an Indian Application Number 5637/CHE/2013 filed on 6 Dec. 2013, the disclosure of which is hereby incorporated by reference herein.

### BACKGROUND ART

Generally, health problems are often caused to people by eating excessive quantity of food. For example, by consuming more calories of food, people become obese. Similarly, by consuming excessive quantities of saturated fats, cholesterol levels in the body increases. Other health problems are caused to people due to insufficient fiber content in their diet. Hence, people's diet should be monitored constantly and remind about their food intake details. For example, there are people with chronic disease like Diabetic; such people must be reminded about regular food intake in specific intervals. Currently, existing fitness and food consumption tracking applications allows the people to remember and manually enter details of food in the application for every meal.

### DISCLOSURE OF INVENTION

### Technical Problem

Some existing systems measure the food consumption information of a user by using different devices associated with the user's articles. For example, some existing systems measures food consumption by using cameras associated with wearable devices, to take pictures of the food being consumed by the user. However, for such systems, the user should manually trigger the devices to provide the input pictures of the food being consumed by the user. In other existing systems, the imaging devices should be focused towards a food source manually. As a result, human intervention is required each and every time when the user is consuming the food which is a cumbersome process.

Thus there remains a need of system and method for automatically capturing the food consumption information of a user.

### Solution to Problem

The principal object of the embodiments herein is to provide a system and method for capturing food consumption information of a user by automatically triggering one or more input means. The input means can be automatically triggered by detecting one or more food consumption actions of the user.

Another object of the embodiments herein is to automatically trigger one or more imaging members to capture plurality of pictures of the food being consumed by the user, when a food consumption action is detected.

Yet another object of the embodiments herein is to automatically trigger one or more voice input means to capture voice data relating to the food being consumed by the user, when a food consumption action is detected.

Yet another object of the embodiments herein is to automatically trigger one or more scanning members to capture code data relating to the food being consumed by the user, when a food consumption action is detected.

Yet another object of the embodiments herein is to automatically identify information relating to the food being consumed by a user based on user's history information, and user's personal preferences, when a food consumption action is detected.

Yet another object of the embodiments herein is to generate one or more recommendations relating to the food being consumed by a user.

Accordingly the embodiments herein provide a method for capturing food consumption information of a subject. The method comprises detecting one or more food consumption action(s) of the subject. If the food consumption action is detected, the method further comprises automatically triggering one or more input means to capture information relating to the food being consumed by the subject.

Accordingly the invention provides an electronic device for capturing food consumption information of a subject, the electronic device comprising an integrated circuit. Further the integrated circuit comprises a processor, and a memory. The memory comprises a computer program code within the integrated circuit. The memory and the computer program code with the processor cause the device to detect one or more food consumption action of the subject. If the food consumption action is detected, the electronic device is further configured to automatically trigger one or more input means to capture information relating to the food being consumed by the subject.

Accordingly the invention provides a computer program product comprising computer executable program code recorded on a computer readable non-transitory storage medium, the computer executable program code when executed, causing the actions including detecting one or more food consumption action of a subject. If the food consumption action is detected, the computer executable program code when executed, causing further actions including automatically triggering one or more input means to capture information relating to the food being consumed by the subject.

### Advantageous Effects of Invention

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the spirit thereof, and the embodiments herein include all such modifications.

### BRIEF DESCRIPTION OF DRAWINGS

This invention is illustrated in the accompanying drawings, throughout which like reference letters indicate corresponding parts in the various figures. The embodiments herein will be better understood from the following description with reference to the drawings, in which:

FIG. 1a illustrates a plurality of members in an electronic device for capturing food consumption information of a user, according to embodiments as disclosed herein;

FIG. 1b illustrates a plurality of members in the electronic device in which an imaging member is placed outside for capturing food consumption information of a user, according to embodiments as disclosed herein;

FIG. 2 is a flow diagram illustrating a method for capturing food consumption information of a user, according to embodiments as disclosed herein;

FIG. 3 shows different input means to capture food consumption information of a user, according to embodiments disclosed herein;

FIGS. 4a-4e shows example illustrations of input members associated with different wearable and non-wearable user's articles to capture food consumption information, according to embodiments disclosed herein;

FIGS. 5a-5i shows different example scenarios of capturing food consumption information of a user using input means associated with different wearable and non-wearable user articles, according to embodiments disclosed herein;

FIGS. 6a, 6b shows example screen shots of a user's electronic device to capture food consumption information by automatically triggering an input means, according to embodiments disclosed herein;

FIG. 7 is a flow diagram illustrating a method for providing a recommendation to the user by locating food being consumed by a user, according to embodiments as disclosed herein;

FIGS. 8a-8c shows different example scenarios of locating food in the vicinity of the user in a particular location using different input means, according to embodiments disclosed herein;

FIG. 9 shows different means to capture food identification data, according to embodiments disclosed herein;

FIG. 10 shows different means to compute food constituents data, according to embodiments disclosed herein;

FIGS. 11a, 11b shows screen shots of a user's electronic device displaying food constituents data, according to embodiments disclosed herein;

FIG. 12 is a flow diagram illustrating a method for providing recommendations to a user relating to the food being consumed, according to embodiments as disclosed herein;

FIGS. 13a-13d shows different example scenarios in providing recommendations to a user, according to embodiments disclosed herein;

FIGS. 14a, 14b shows example screen shots of a user's device displaying generated recommendations according to embodiments disclosed herein;

FIG. 15 shows different means of identifying a user profile before capturing food consumption information, according to embodiments disclosed herein; and

FIG. 16 illustrates a computing environment implementing the system and methods described herein, according to embodiments as disclosed herein.

### MODE FOR THE INVENTION

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. Also, the various embodiments described herein are not necessarily mutually exclusive, as some embodiments can be combined with one or more other embodiments to form new embodiments. The term “or” as used herein, refers to a non-exclusive or, unless otherwise indicated. The examples used herein are intended merely to facilitate an understanding of ways in which the embodiments herein can be practiced and to further enable those of skill in the art to practice the embodiments herein. Accordingly, the examples should not be construed as limiting the scope of the embodiments herein.

The embodiments herein achieve a method and system for capturing food consumption information of a subject. The subject can be a user whose diet should be monitored. In an embodiment, the method includes automatically triggering one or more input means to capture information relating to the food being consumed by the subject (user). In an embodiment, the food includes but is not limited to a solid food, liquid nourishment (such as beverages), medicine and water. The input means can be automatically triggered by detecting one or more food consumption actions of the user. For example, the input means can be, but not limited to an imaging member, a voice input means, user's historic information, user's personalized preferences, and a scanning member and so on. In an embodiment, the input means can be a wearable or non-wearable members associated with user's articles. Further, the method includes generating one or more recommendations relating to the captured food information. Furthermore, the method includes providing the generated recommendations to the user and/or to a guardian of the user.

Unlike conventional systems, the disclosed method and system does not require any manual intervention and can automatically trigger one or more input means to capture the food consumption information of the user. The input means can be, but not limited to, an imaging member, a scanning member, and a voice recognition member. In the existing system, only the imaging member is used to capture the food consumption of the user, whereas the proposed method uses different input means to capture the food consumption information. Further, in the proposed method, plurality of input means work together and detect the food consumption information. Thus, the proposed method enhances the user experience while consuming the food.

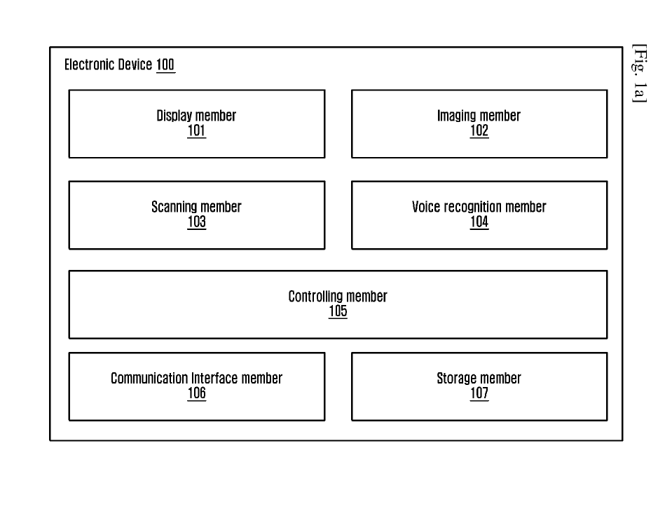

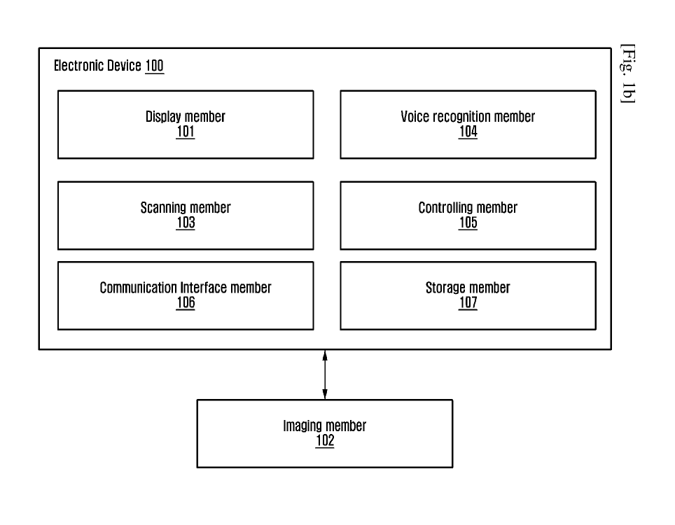

Referring now to the drawings, and more particularly to FIGS. 1 through 16, where similar reference characters denote corresponding features consistently throughout the figures, there are shown preferred embodiments.

FIG. 1a illustrates a plurality of members in an electronic device 100 for capturing food consumption information of a user, according to embodiments as disclosed herein. The electronic device 100 includes a display member 101, an imaging member 102, a scanning member 103, a voice recognition member 104, a controlling member 105, a communication interface member 106, and a storage member 107. The electronic device 100 can be any kind of computing device, such as, but not limited to, a laptop computer, Personal Digital Assistant (PDA), mobile phone, smart phone, or any electronic computing device which has been configured to perform the functions disclosed herein. In an embodiment, the electronic device 100 can be a wearable device, for example, a wrist watch.

The display member 101 can be configured to allow the user to provide user's personalized food data. Further, the display member 101 can be configured to provide the recommendations relating to the food being consumed by the user. For example, the recommendation output can be audio, visual, text, voice, photo, light, vibration, ring tone or essentially any other type of output.

The imaging member 102 captures one or more pictures of the food being consumed by the user. For example, the imaging member is a camera. In an embodiment, the imaging member 102 automatically captures the pictures of the food located in the vicinity of the user.

The scanning member 103 scans the code (for example, RFID or bar code) available in the food material being consumed by the user. In an embodiment, the scanning member 103 automatically scan the code available in the food located in the vicinity of the user. The located food in the vicinity of the user can be the food items consumed by the user daily. The voice recognition member 104 captures the voice input, relating to the food consumed by the user.

In an embodiment, the controlling member 105 can be configured to automatically trigger the input means to capture information relating to the food being consumed by the user. The input means can be automatically triggered by detecting one or more food consumption actions of the user. For example, when the user starts consuming the food, the controlling member 105 automatically triggers an imaging member, such as a camera, to capture a plurality of pictures of the food. Further, each input means is capable of performing one or more functions such as, but not limited to, eating pattern recognition, human motions, facial recognition, gesture recognition, food recognition, voice recognition, bar code recognition and so on.

The controlling member 105 can be configured to identify information related to the food being consumed by the user. For example, if the user is consuming liquid nourishment, the controlling member 105 identifies information, such as protein, calorie, nutrient, fat, sugar, carbohydrates, and so on, related to the liquid nourishment. In an embodiment, while displaying the data, quantitative values may be associated with the constituents, and can be measured in any suitable units such as teaspoons or grams. Furthermore, the controlling member 105 can be configured to generate and provide recommendations to the user, relating to the identified food information. In an embodiment, the controlling member 105 can be configured to provide recommendation about the food located in the vicinity of the user.

Further, the controller member 105 can be configured to generate the recommendation to the user relating to the food consumed or about the food located within the vicinity of the user. In an embodiment, the controlling member 105 can be configured to dynamically switch the profile associated with the user by detecting a pattern of food consumption action of the user.

In an embodiment, the communication interface member 106 provides various communication channels between the electronic device 100 and other devices connected to the system. The communication channel can be a wireless communication such as, but not limited to, a Bluetooth, Wi-Fi, and the like. For example, after generating the recommendations relating to the food being consumed by the user in the electronic device 100, the controlling member 105 provides the generated recommendation to guardian or care taker of the user through the communication interface member 106. In an embodiment, the communication interface member 106 can be configured to provide necessary communication channels to correlate the captured information with the food item descriptive table available in an online database.

In an embodiment, the storage member 107 stores the user's food history data and user's personalized preferences. In an embodiment, the storage member 107 stores the food item descriptive table which includes the details of all available food, for example, constituent data (such as calorie, proteins and the like), pictures, and videos of each food item.

FIG. 1b illustrates a plurality of members in the electronic device 100 in which an imaging member is placed outside for capturing food consumption information of a user, according to embodiments as disclosed herein. In an embodiment, the imaging member can be placed outside of the electronic device 100 by associating with user's wearable or non-wearable articles such as, but not limited to, a wrist watch, bracelet, finger ring, necklace, ear ring, mug (a beverage container) and so on. For example, one or more imaging members may be worn on the user's body by associating with articles such as a wrist watch, ring, necklace, and the like. For example, one or more imaging members may be positioned in proximity to the user's body by associating with user's articles such as a mug, glass tumbler and the like. In an embodiment, a user article can be associated with two or more imaging members. For example, two or more imaging members can be associated within the wrist watch of the user.

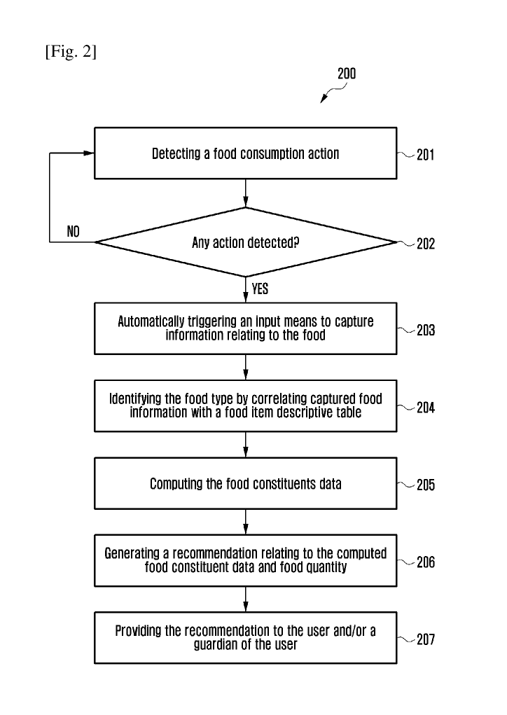

FIG. 2 is a flow diagram illustrating a method 200 for capturing food consumption information of a user, according to embodiments as disclosed herein. At step 201, the method 200 includes detecting a food consumption action of the user. The method 200 allows the controlling member 105 to detect food consumption action of the user by using different sensors, such as on-device sensors, external sensors, software sensors (for example, application installed in the electronic device 100 to scan barcode), and hardware sensors. In an embodiment, the method 200 allows one or more imaging members, such as a camera, to detect the food consumption action of the user. The imaging member can be associated with user's articles such as wrist watch, glass, and the like. In an embodiment, the method 200 includes detecting the food consumption action based on user's food history data such as past eating habits, previous detections, and so on. In an embodiment, the method 200 includes detecting the food consumption action based on articles used to consume the food by the user. For example, when the user uses food accessories such as smart fork, smart spoon, and the like, the method 200 detects that the user is consuming the food.

At step 202, the method 200 includes determining whether any food consumption action is detected. The method 200 allows one or more sensors associated with user's articles, to detect the food consumption action. The different sensors includes accelerometer, inclinometer, motion sensor, sound sensor, smell sensor, blood pressure sensor, heart rate sensor, EEG sensor, ECG sensor, EMG sensor, electrochemical sensor, gastric activity sensor, GPS sensor, location sensor, image sensor, optical sensor, piezoelectric sensor, respiration sensor, strain gauge, electrogoniometer, chewing sensor, swallow sensor, temperature sensor, and pressure sensor. For example, when the user performs actions like moving hand with a spoon towards his/her mouth, rolling of hand, wrist, or arm, acceleration or inclination of lower arm or upper arm, bending of the shoulder, elbow, wrist, or finger joints, movement of the jaws, the sensors or imaging members associated with the user's articles, such as a wrist watch or mug, determine that the food consumption action is detected.

At step 203, the method 200 includes automatically triggering the input means to capture information relating to the food if the food consumption action is detected. The method 200 allows the controlling member 105 to automatically trigger one or more input means. The input means can be, but not limited to, an imaging member (such as a camera), a voice input means, user's historic information, user's personalized preferences, and a scanning member (such as a RFID/Bar code scanner) and so on. For example, when the food consumption action is detected, the voice input means is automatically triggered and provides a request to the user to feed the input. Further, the voice input means captures voice commands provided by the user. In an embodiment, the method 200 allows the user to select a method of providing the input means among the variety of input means available.

At step 204, the method 200 includes identifying the food type by correlating the captured food information with the food item descriptive table. The food item descriptive table can be configured to store all available food details, for example, constituent data of each food (such as calorie, proteins and the like), pictures, videos, and so on. The food item descriptive table can be an online database providing the details of the food. The method 200 allows the communication interface member 106 to provide necessary communication channels to correlate the captured information with the food item descriptive table. The database may also contain real-time user location, body mass index (BMI) history, medical history, risk factors associated with various diseases and medical conditions such as obesity and diabetes, demographic diversity, availability of food resources to the user at various times of the day, and relevant epidemiological parameters, and so on. In an embodiment, the food item descriptive table can be stored in the storage member 107. In an embodiment, the food item descriptive table can be associated with the server. In an embodiment, any suitable communication channel can be used to provide communication between the electronic device 100 and server. For example, the communication channel can be, but not limited to, a wireless network, wire line network, public network such as the Internet, private network, general packet radio network (GPRS), local area network (LAN), wide area network (WAN), metropolitan area network (MAN), cellular network, public switched telephone network (PSTN), personal area network, and the like. The method 200 allows the controlling member 105 to correlate the captured food information with the information available in the food item descriptive table. For example, the imaging member, such as a camera, captures a plurality of pictures of the food being consumed by the user. Further, the controlling member 105 correlates the captured food pictures with the online food item descriptive table and identifies the food type. In an embodiment, the method 200 allows the electronic device 100 to identify the location of the user by using suitable techniques such as GPS or by receiving manual or voice inputs from the user. The electronic device 100 may store a record of time and location at which the user consumes the food item for each and every occurrence. For example, sometimes the user consumes food items at outdoors such as, restaurants, hotels, and so on. The method 200 allows the electronic device 100 to provide the location and time details in the food history.

At step 205, the method 200 includes computing the food constituent's data. The food constituent's data includes information about the food being consumed by the user. For example, constituents such as calories, proteins, fat, carbohydrates, protein, amino acids and so on present in the food. The method 200 allows the controlling member 105 to compute the food constituent's data by matching identified food information with the food item descriptive table.

At step 206, the method 200 includes generating a recommendation related to the computed food constituents data and food quantity. The method 200 allows the controlling member 105 to generate the recommendation by analyzing the pictures of the user mouth and the captured pictures of the food reachable to the user mouth. In an embodiment, recommendations related to user's health, such as exercise plans, absence of food activity by the user and so on are generated and suggested to the user. For example, when current values of the user's periodic nutritional parameters reach maximum or sufficient, a recommendation is generated indicating the same to the user. In an embodiment, the recommendations can be based on user's historic information. For example, if the user consumes medicine before his/her meal every day, a recommendation is generated to the user if the user forgets to take the medicine before his/her meal. For example, the method 200 concludes that the user should not eat the food item and then recommend the user accordingly. The recommendation is generated, for example, based on the food identification data and the user's personalized food preferences. For example, if the identified food contains one or more items to which the user is allergic or intolerant or dislikes, the recommendation is generated indicating that the user should not eat the food. In an embodiment, the recommendations may include diet quality score of the user for a day or week or month based on nutrition or guardian advice.

At step 207 the method 200 includes providing the recommendation to the user and/or to a guardian of the user. The method 200 allows the display member 101 to display the recommendation to the user on the user's electronic device 100. In an embodiment, the recommendation can be displayed on the wearable or non-wearable input members, such as wrist watch, spectacles, and so on placed in the proximity of the user. In an embodiment, the recommendation can be shared as a notification in user's social network based on the user preference.

In an embodiment, the recommendation can be provided before, during or after the food consumption of the user. In an embodiment, the recommendations can be notifications such as an electronic mail (email), push notification, instant message or text message (like short message service (SMS) text or multimedia messaging service (MMS) text), and so on. For example, an image or video can be sent as a MMS to show the junk food consumed by the user.

For example, recommendation is provided using a text, voice, photo, video, light, vibration, and ring tone.

In an embodiment, the recommendation is related to exercise, food wastage, illness, obesity, and dietary restriction.

The various actions, acts, blocks, steps, and the like in method 200 may be performed in the order presented, in a different order or simultaneously. Further, in some embodiments, some actions, acts, blocks, steps, and the like may be omitted, added, modified, skipped, and the like without departing from the scope of the invention.

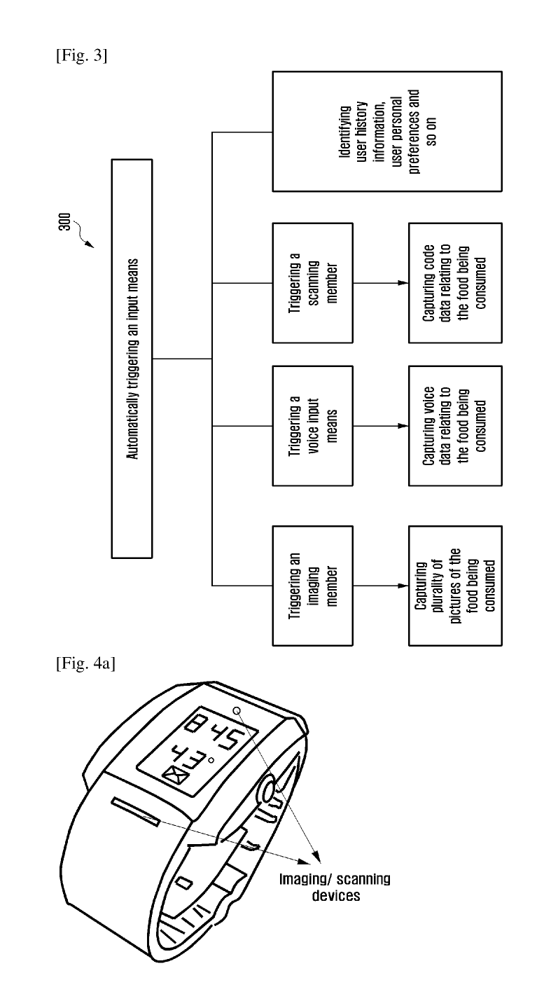

FIG. 3 shows different input means 300 to capture food consumption information of a user, according to embodiments disclosed herein. In an embodiment, the input means can be an imaging member, such as an image processing device. When the food consumption action is detected, the imaging member associated with the imaging member 102 is triggered automatically to capture plurality of pictures of the food being consumed by the user. In an embodiment, the pictures can be motion pictures (video). For example, when the user starts consuming the food, the camera device in the wrist watch of the user gets triggered automatically to capture pictures of the food items being consumed by the user. In an embodiment, the imaging member 102 is automatically triggered to capture the pictures of the food located in the vicinity of the user.

In an embodiment, the input means can be a manual input, such as a voice. When the food consumption action is detected, the voice input means associated with the voice recognition member 104 is automatically triggered to capture voice data relating to the food being consumed by the user. For example, when the user is taking the food, the voice recorder associated with the wrist watch of the user is triggered automatically and captures the voice input provided by the user (name or other description of the food item).

In an embodiment, the input means can be a scanning member, such as a RFID scanner or a Barcode scanner. When the food consumption action is detected, the scanning member associated with the scanning member 103 is triggered automatically to capture the coded data such as Universal Product Code (UPC), RFID tag and the like relating to the food being consumed by the user. For example, when the user starts consuming snacks from a pack, the scanning member is triggered automatically and captures the code data from the pack.

In an embodiment, the food consumption information of the user can be captured by identifying user's history information, and user's personalized preferences. For example, the user configures his/her personalized preferences in the electronic device 100. User configures breakfast food item as a burger. Hence, whenever, the food consumption is detected in the breakfast time, the food item is captured as a burger.

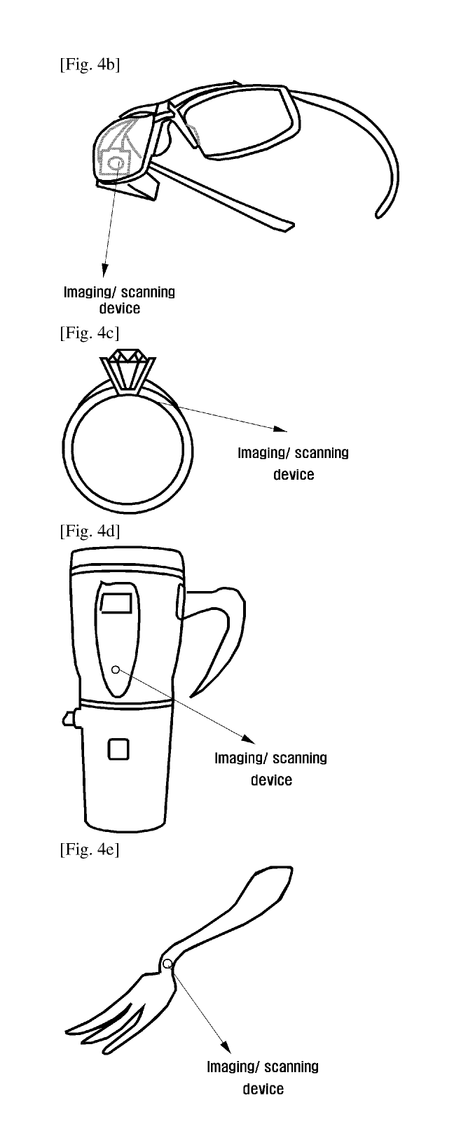

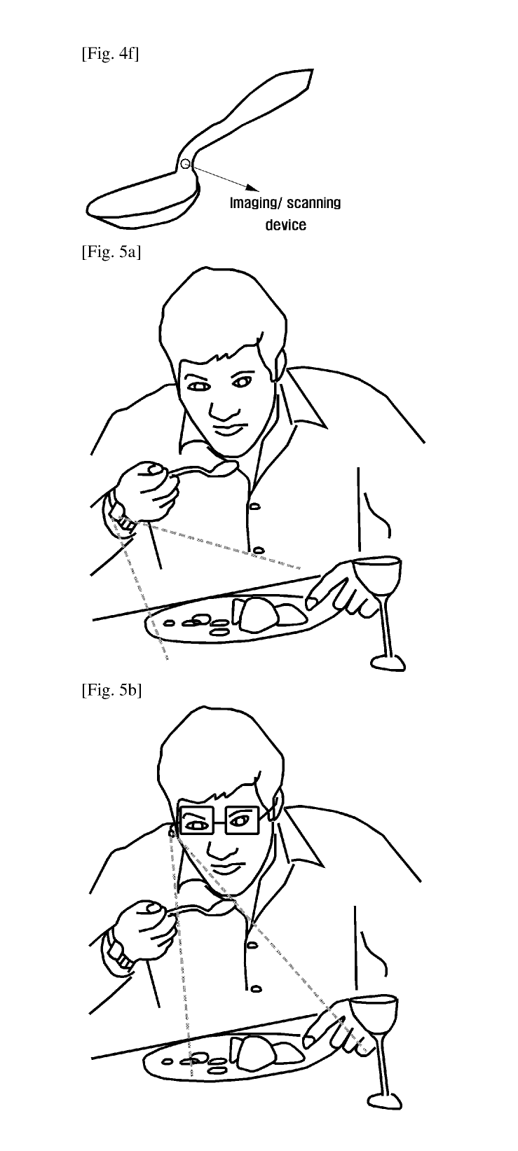

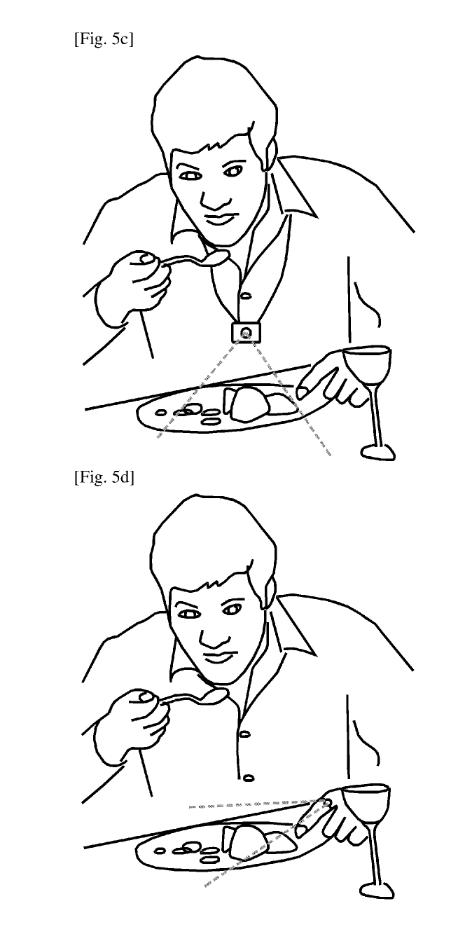

FIGS. 4a-4e shows example illustrations of the input members associated with different wearable and non-wearable user's articles to capture food consumption information, according to embodiments disclosed herein. The input members can be an imaging member, a voice input means, and a scanning member. Each user article may contain one or more input members. FIGS. 4a, 4b, and 4c illustrate input members associated with different wearable user articles such as a wrist watch, spectacles, and ring. FIGS. 4d, 4e, and 4f illustrate input members associated with different non-wearable user articles such as a mug (such as coffee mug), fork, and spoon. These input members are automatically triggered when the user food intake action is detected.

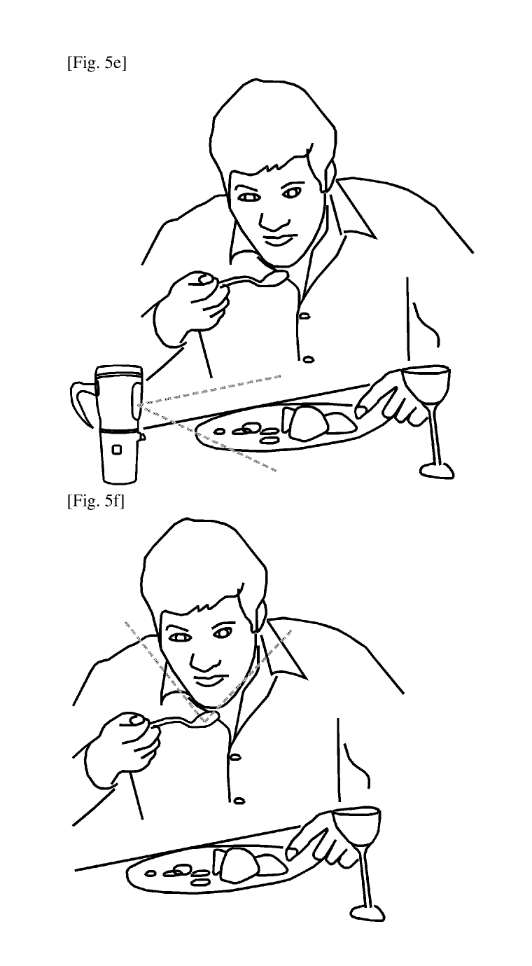

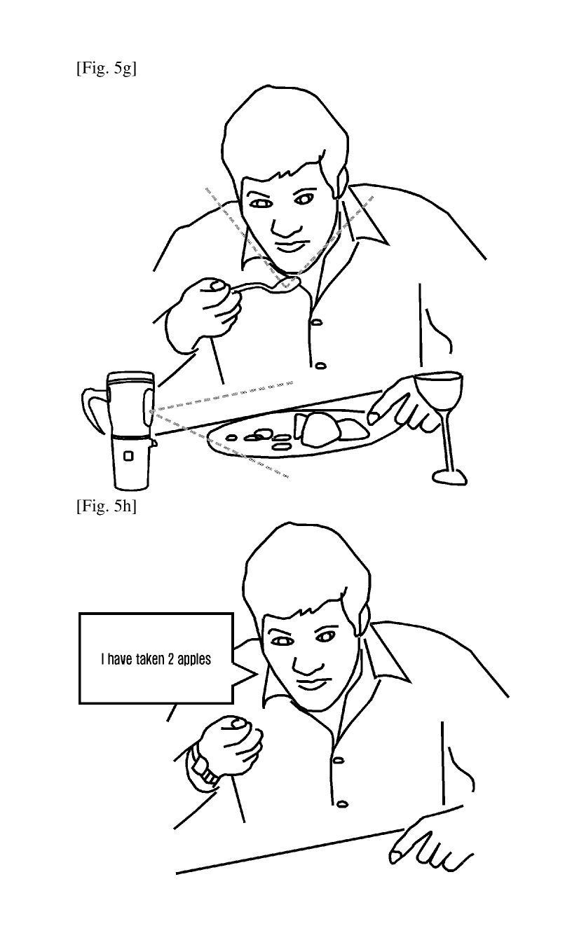

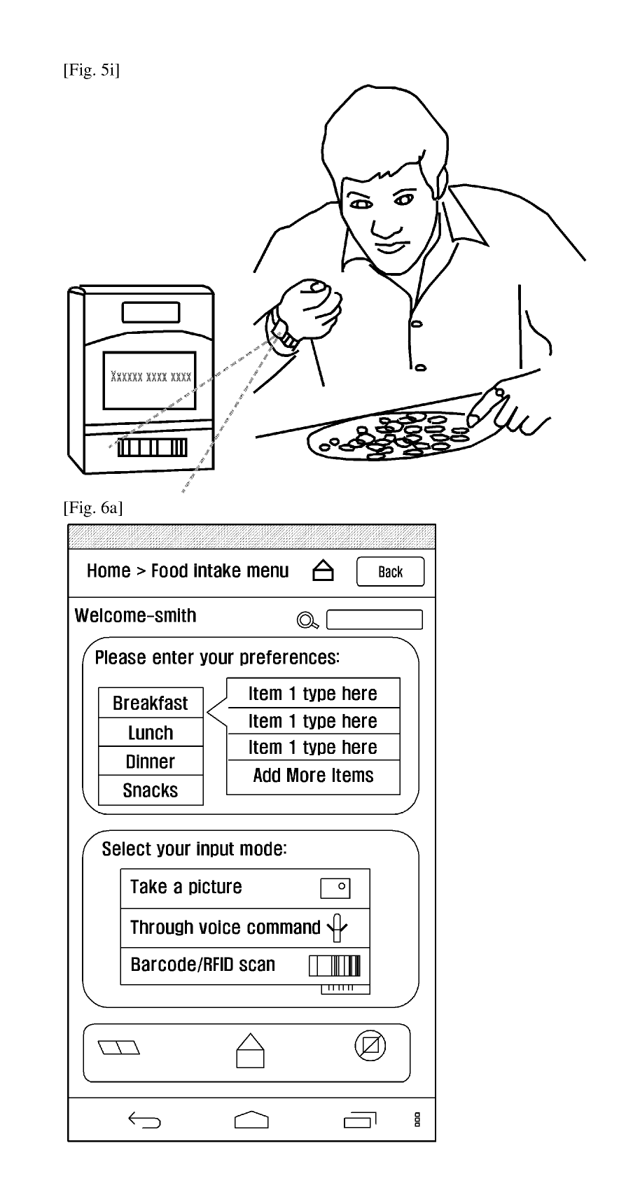

FIGS. 5a-5i shows different example scenarios of capturing food consumption information of a user using different input means associated with different wearable and non-wearable user articles, according to embodiments disclosed herein. The FIGS. 5a-5g depicts a user seated at table, and consuming a piece of food from the reachable food source using a spoon. In the FIGS. 5a-5d the user is wearing different input members associated with different articles worn by the user on body. In the FIGS. 5e-5g the input members are positioned in proximity to the user. The dotted lines in the figures depict the area captured to identify the food information.

FIG. 5a depicts the example scenario of capturing food consumption information of the user using the input member associated with the user's wrist watch.

FIG. 5b depicts the example scenario of capturing food consumption information of the user using the input member associated with user's spectacles.

FIG. 5c depicts the example scenario of capturing food consumption information of the user using the input member associated with wearable chain in neck.

FIG. 5d depicts the example scenario of capturing food consumption information of the user using the input member associated with user's ring.

FIG. 5e depicts the example scenario of capturing food consumption information of the user using the input member associated with a mug placed in proximity to the user.

FIG. 5f depicts the example scenario of capturing food consumption information of the user using the input member associated with a food accessory (spoon).

FIG. 5g depicts the example scenario of capturing food consumption information of the user using multiple input members associated with food accessories (mug and spoon).

FIG. 5h depicts the example scenario of capturing food consumption information of the user using the voice input means associated with the user's wrist watch.

FIG. 5i depicts the example scenario of capturing food consumption information of the user using the scanning input member associated with the user's electronic device 100.

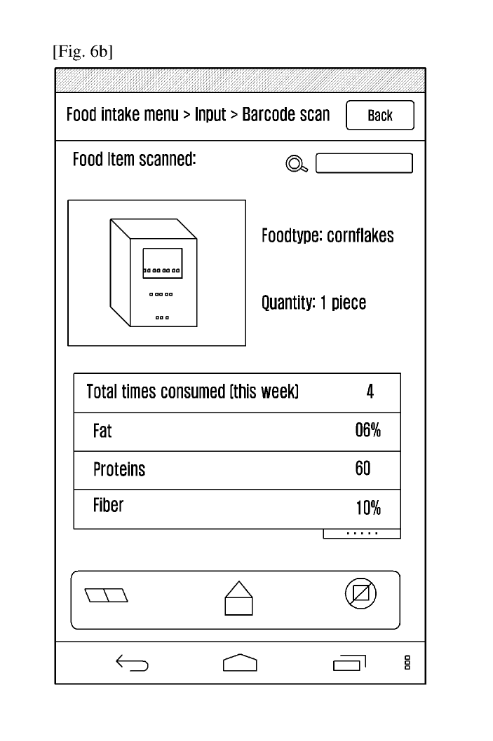

FIGS. 6a, 6b shows example screen shots of a user's electronic device 100 to capture food consumption information by automatically triggering an input means, according to embodiments disclosed herein. FIG. 6a depicts example screen shot while configuring user personalized food preferences. As depicted in the FIG. 6a, the user can configure his/her food preferences for different scenarios like breakfast, lunch, snacks and dinner. In an embodiment, the user may assign rankings to the food items relative to each other. For example, the user configures two food items, a Burger and a Bagel as preference. The user prefers the food item Burger more than the food item Bagel. Hence, the user assign rank 1 to the food item Burger and rank 2 to the food item Bagel. In an embodiment, the controlling member 105 may add or edit the personalized food data by observing the user's selections of food to eat or not. The user can selects a default input means to trigger automatically when a food consumption action is detected For example, if the user selects Barcode/RFID scanner as default input means, the Barcode/RFID scanning member associated with user articles is triggered automatically when the food consumption action is detected. The FIG. 6b depicts the example screen shot after the scanning member captures the code relating to the information of the food being consumed by the user. The FIGS. 6a and 6b also depict information about the food avoided by the user. For example, the information includes food wastage, food items avoided and so on.

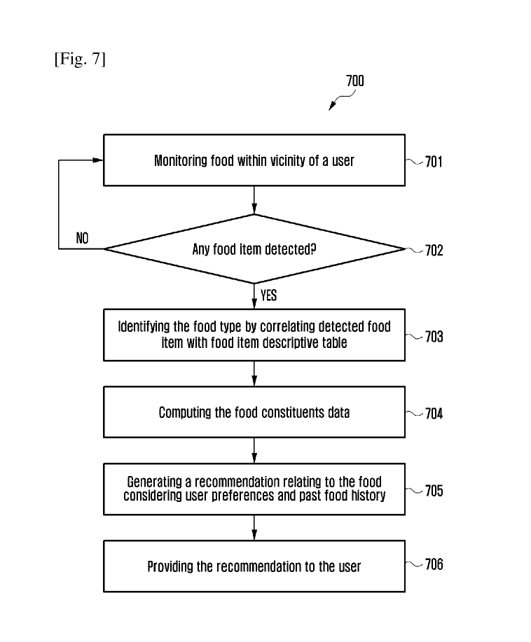

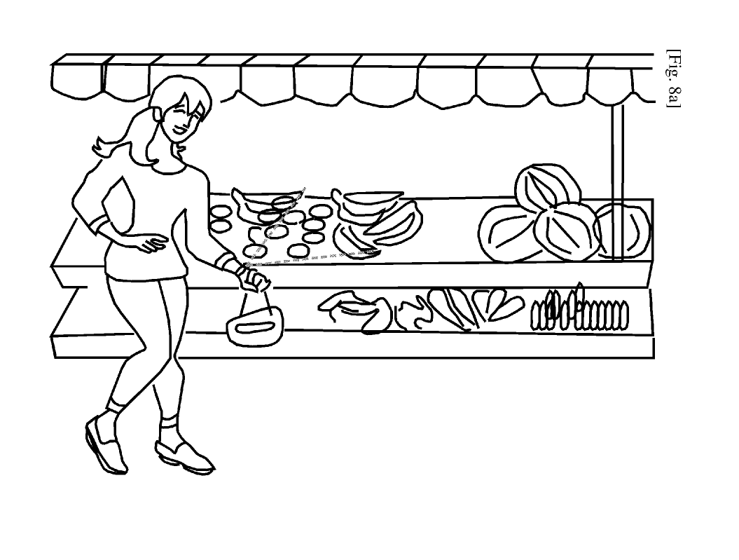

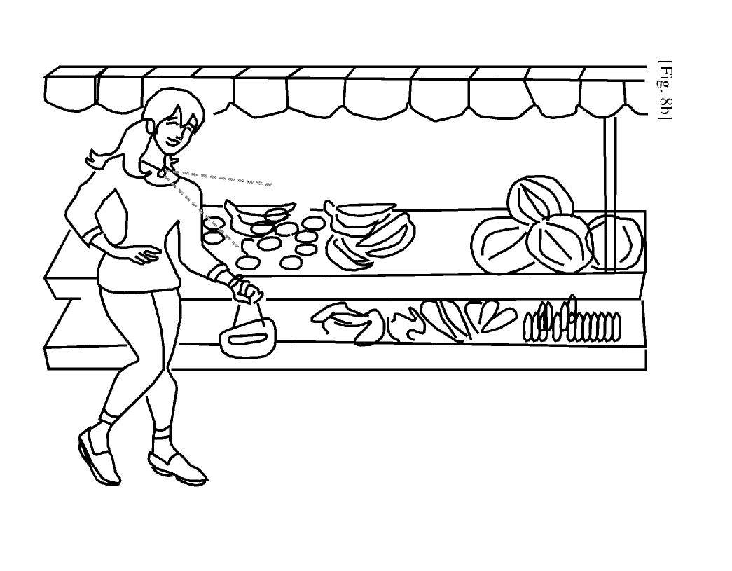

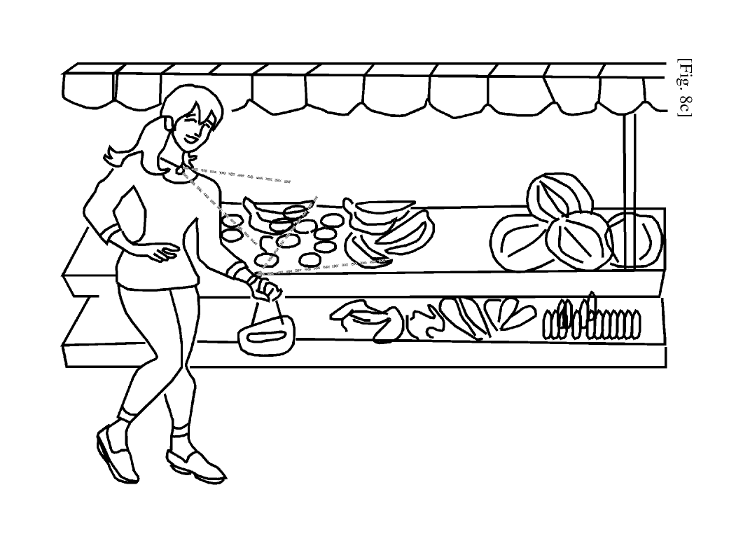

FIG. 7 is a flow diagram illustrating a method 700 for providing a recommendation to the user by locating food being consumed by a user, according to embodiments as disclosed herein. At step 701, the method 700 includes monitoring food within the vicinity of the user. In an embodiment, the food within the vicinity of the user can be monitored using the sensors such as Gas chromatography, GC-mass spectrometry, mass spectrometry in non-vacuum environment, Atmospheric Pressure Chemical Ionization, Micro Electro-Mechanical Systems (MEMS), ion mobility spectroscopy, dielectrophoresis, infrared spectroscopy, near-infrared spectroscopy, chemical and conductometric sensors, electronic nose sensors, synthetic olfaction sensors, solid state sensors, Raman sensors, photo analysis, 3D photo modeling, video analysis, biosensors, bio-mimetic systems, photometric sensors, bar code scanning, reading of Radio Frequency Identification tags, micro-cantilevers, nano-cantilevers, and any miniaturized equipment developed to smell gas molecules such as volatile organic compounds and peptides.

At step 702, the method 700 includes determining whether any food item is detected at the hands of the user. For example, when the user is buying grocery, the input members associated with the user's necklace monitors for food items at the hands of the user.

At step 703, the method 700 includes identifying the food type by correlating the captured food information with the food item descriptive table stored in the storage member 107. In an embodiment, the food item descriptive table can be associated with the server. In an embodiment, the food item descriptive table can be an online database. In an embodiment, the identification can be performed by analyzing the food's shape, color, texture, and volume; or by analyzing the food's packaging and so on. For example the food type identified as liquid based on color, and other characters captured in the picture, exact food item is identified. In an embodiment, the identified food data may include the details such as, but not limited to, origin of the food, for example, the geographic location in which the food was grown, manufactured, prepared, and packaged. The information can be collected from the food tem descriptive table. For example, when the camera in the wrist watch of the user captures plurality of pictures of a food item, the controlling member 102 correlates the captured images with images stored in the food descriptive table.

At step 704, the method 700 includes computing the food constituent's data. The method allows the controlling member 102 to compute the food constituent's data by matching the food type with the information present in the food descriptive table. For example, if the food identified is a cheese burger, the constituent's data is computed based on the information available for cheese burger in the food descriptive table.

At step 705, the method 700 includes generating a recommendation relating to the food, considering the user personalized preferences and the user past food history information. At step 706, the method 700 includes providing the recommendations to the user. For example, the user is consuming an apple daily after his/her meal. Further, the controlling member 105 monitors the food item apple in the vicinity of the user. When the food item is detected as the ‘apple’ within the vicinity of the user, a recommendation is generated and provided to the user indicating that apple is available within the vicinity of the user.

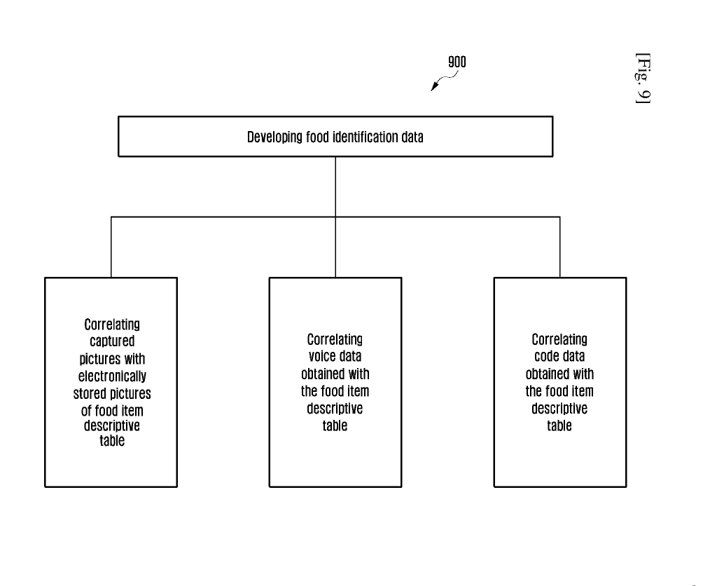

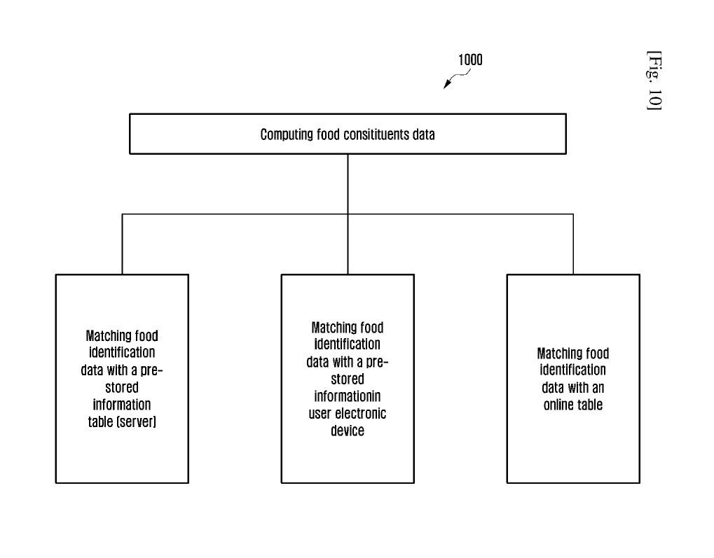

FIGS. 8a-8c shows different example scenarios locating food in the vicinity of the user in a particular location using different input means, according to embodiments disclosed herein.

FIG. 8a depicts the example scenario of locating food within the vicinity of the user, using the input member associated with the user's spectacles. As depicted in the FIG. 8a, the imaging member (camera) associated with the user's wrist watch identifies the availability of the food item in a shop while the user is walking near the shop.

FIG. 8b depicts the example scenario of locating food in the vicinity of the user in a particular location, using the input member associated with the user's chain.

FIG. 8c depicts the example scenario of locating food in the vicinity of the user in a particular location using multiple input members associated with the user's wearable articles such as a necklace, and a wrist watch.

FIG. 9 shows different means 900 to capture food identification data, according to embodiments disclosed herein. After capturing the information relating to the food being consumed by the user (by triggering any of the input means as described in the FIG. 3), food identification data is developed. In an embodiment, the food identification data can be developed by correlating the captured pictures with electronically stored pictures of the food item descriptive table. Further, correlating the captured pictures with electronically stored pictures may include analyzing picture of the user mouth and the captured pictures of the food reachable to the user mouth in order to estimate the quantity of the food being consumed by the user. For example, the camera associated with the ring of the user captures plurality of pictures of the food being consumed by the user. Further, the food identification data can be developed by correlating these pictures with the pictures stored in the database.

In an embodiment, the food identification data can be developed by correlating the voice data obtained from the user with the food item descriptive table. For example, the voice recorder associated with the electronic device 100 of the user captures voice commands of the user. Further, the food identification data can be developed by correlating this voice data with the data in the food descriptive table.

In an embodiment, the food identification data can be developed by correlating the code data obtained with the data available in the food item descriptive table. For example, the Barcode scanning member associated with the mug captures barcode printed on the food packet present in the proximity of the user. Further, the food identification data can be developed by correlating this captured code data with the data in the food descriptive table.

FIG. 10 shows different means to compute food constituents data, according to embodiments disclosed herein. Once the food identification data is developed, the constituents of the identified food is computed. In an embodiment, the constituent's data of the identified food can be computed by matching the data with data available in the food item descriptive table. For example, the identified food type is a Pepperoni Pizza. Further, the constituents of the Pepperoni Pizza are computed by using the data available for Pepperoni Pizza in the food item descriptive table.

In an embodiment, the constituent's data of the identified food can be computed by matching the data with pre-stored data available in the electronic device 100. In an embodiment, the constituent's data of the identified food can be computed by matching the data with an online database.

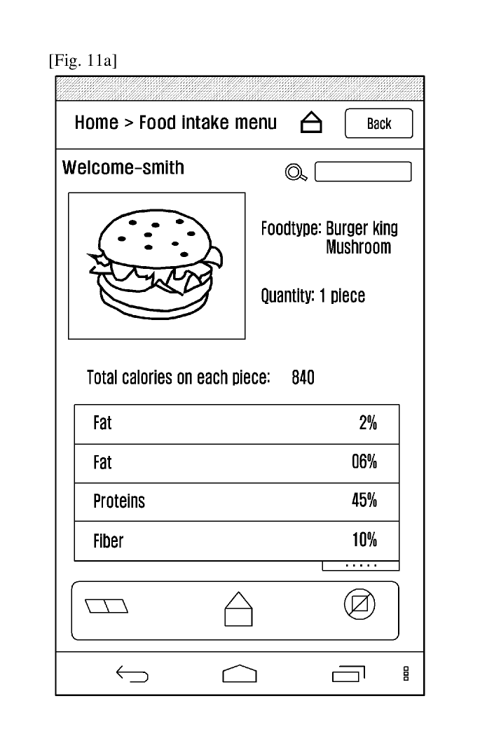

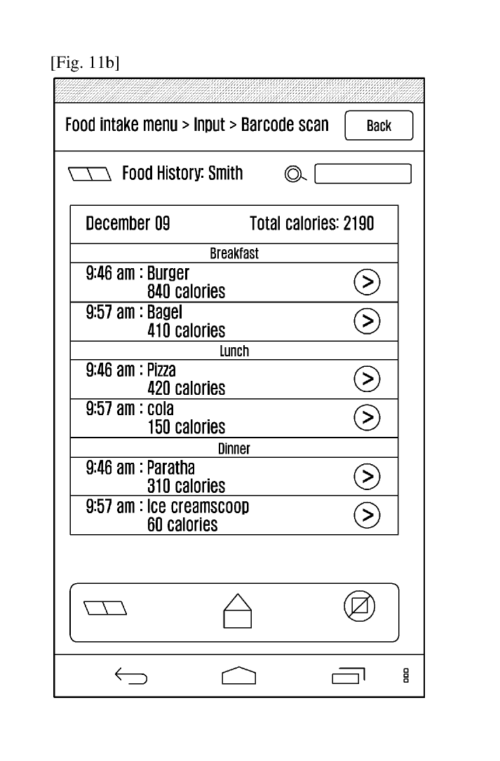

FIGS. 11a, 11b shows screen shots of a user's electronic device 100 displaying food constituent's data, according to embodiments disclosed herein. The FIG. 11a shows the screen shot of the electronic device 100 depicting the constituents of the food ‘Burger King Mushroom’. Further, a variety of information about the food item is displayed to the user. For example, the input members sense the characteristics of the Burger King Mushroom, and the controlling member 105 may identify the Burger King Mushroom by name. Further, based on the ingredients used for making the Burger King Mushroom, constituent's data is computed and displayed to the user. The FIG. 11a also depicts the profile information associated with the user, such as name (‘smith’), past food history, avoided food, and so on. The past food history provides the history of all food items such as item name, quantity, time, and location and so on. The avoided food provides the information regarding the food items that are avoided or wasted previously by the user.

FIG. 11b shows the screen shot of the user electronic device 100 depicting the food history of the user. As depicted in the FIG. 11b, the electronic device 100 displays the data from the current day of the user's food history information in the form of a personal food diary listing the foods that the user consumed in breakfast, lunch, and dinner. For example, as depicted in the FIG. 11b, the user ‘Smith’ consumes the food items Burger having 840 calories and Bagel having 410 calories for his breakfast. The FIG. 11b depicts total calories consumed by the user for whole day. For example, as depicted, the user ‘smith’ consumed 2190 calories for the day.

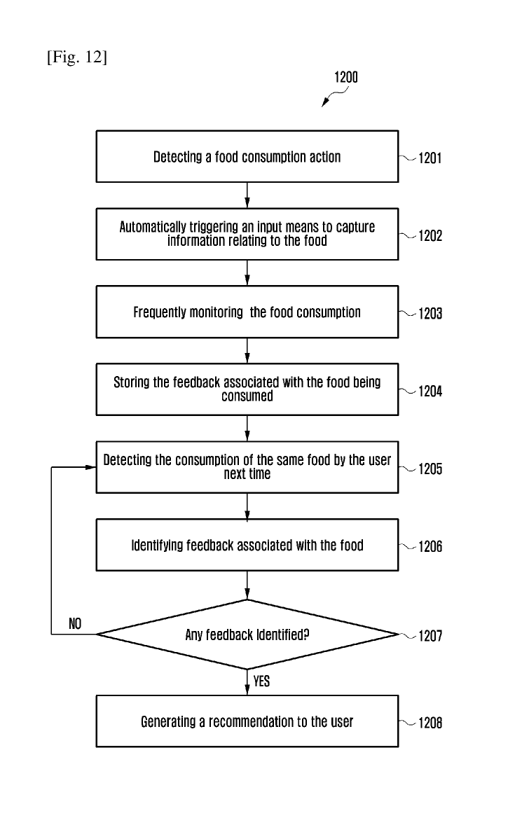

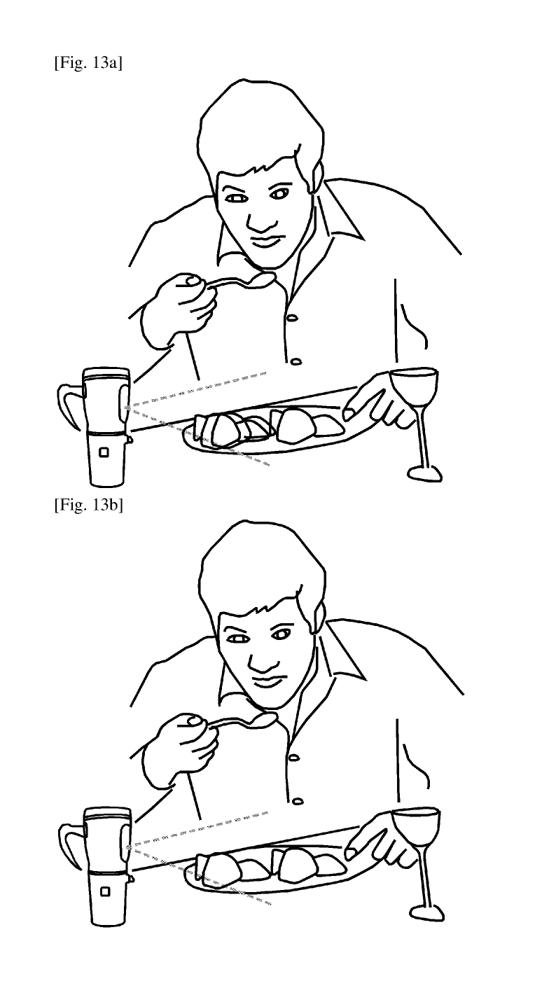

FIG. 12 is a flow diagram illustrating a method 1200 for providing recommendations to a user relating to the food being consumed, according to embodiments as disclosed herein. At step 1201, the method 1200 includes detecting the food consumption action of the user. The method 1200 allows different sensors, cameras, associated with wearable or non-wearable user's articles, to detect the food intake action of the user. At step 1202, the method 1200 includes automatically triggering the input means to capture the information of the food. The input means can be, but not limited to an imaging member, a voice input means, user's historic information, user's personalized preferences, and a scanning member and so on. For example, the controlling member 105 detects the food intake action by identifying the user's food historic information (based on recorded time). Every day user takes his/her breakfast at 8'O clock in the morning. Hence, the controlling member 105 automatically triggers the camera associated with the user's articles at 8'O clock in the morning.

At step 1203, the method 1200 includes frequently monitoring the food consumption of the user. For example, the cameras associated with the user's articles captures the pictures of the food being consumed by the user at regular intervals of time until the food consumption action is completed. At step 1204, the method 1200 includes storing the feedback associated with the food being consumed by the user. The method 1200 allows the storage member 107 to store the details of the food, such as type of food, quantity of the food consumed by the user, quantity of the food wasted and so on. For example, if the user has finished eating a meal, the user food history information is updated including a record of the leftover or wasted food. In an embodiment, the feedback information can also be stored in the food item descriptive table.

At step 1205, the method 1200 includes detecting the consumption of same food by the user next time. At step 1206, the method 1200 includes identifying the feedback associated with the food being consumed. For example, the user is consuming an apple, the controlling member 105, identifies if there is any feedback associated with the apple, when the user consumes apple previous time. At step 1207, the method 1200 includes determining any feedback associated with the food being consumed by the user. At step 1208, the method 1200 includes generating the recommendation in response to determining that there is feedback associated with the food. For example, previously the user wasted 2 pieces of apple. Hence, the controlling member 105 generates the recommendation indicating the wastage of the same food previously. At step 1207, the method 1200 repeats from step 1205, if it is determined that there is no feedback identified associated with the food. Further, the method 1200 includes providing the generated recommendation to the user. In an embodiment, the recommendations include frequency of food consumption, meal reminders, eating limitations, exercise recommendations, food log recommendations, food wastage notifications, restrictions, medical conditions, food intake histories and the like. The user may accept or reject the recommendation provided by the system. For example, the recommendations may include nutrition advice for a diabetic user with a particular amount of insulin at a particular time, based on the user's personalized food data.

The various actions, acts, blocks, steps, and the like in method 1200 may be performed in the order presented, in a different order or simultaneously. Further, in some embodiments, some actions, acts, blocks, steps, and the like may be omitted, added, modified, skipped, and the like without departing from the scope of the invention.

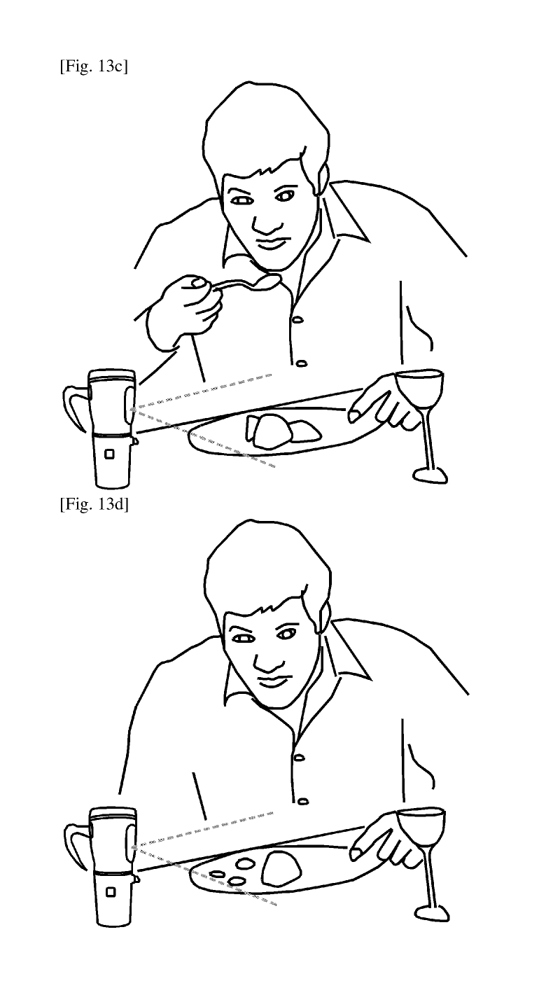

FIGS. 13a-13d shows different example scenarios in providing recommendations to a user, according to embodiments disclosed herein. As depicted in the FIGS. 13a-13d, the input means associated with the user's articles frequently monitors the food being consumed by the user until the user ends the food consumption action. In FIG. 13d, the user finished consuming the food. Hence, the quantity of the food being wasted is stored as the feedback in the storage member 107. In an embodiment, the feedback information can also be stored in the food item descriptive table. Further, when the user consumes the same food again, the food is detected and the feedback associated (regarding the wastage) with the food is identified. Furthermore, a recommendation is generated and provided to the user to take less quantity as the food was wasted last time by the user.

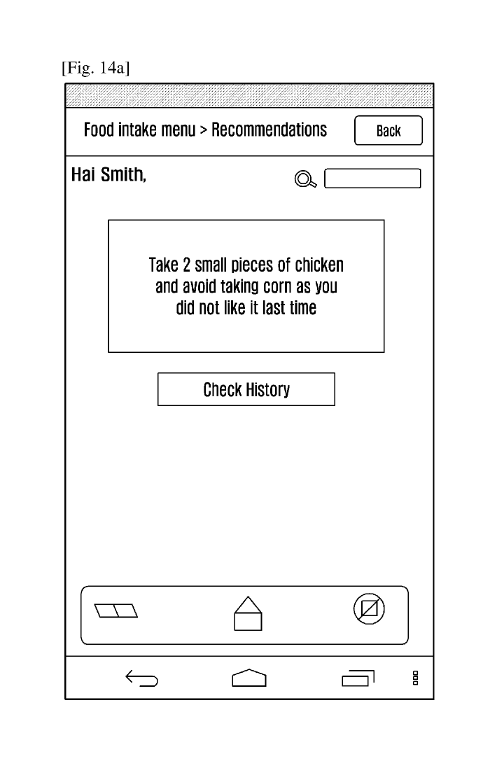

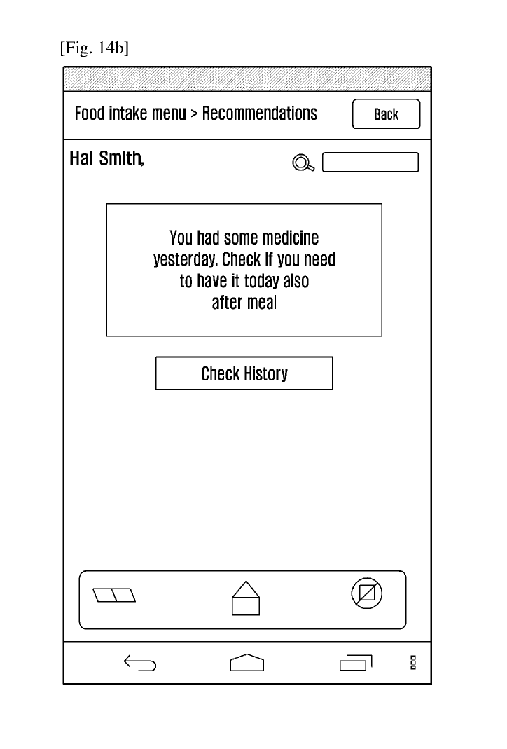

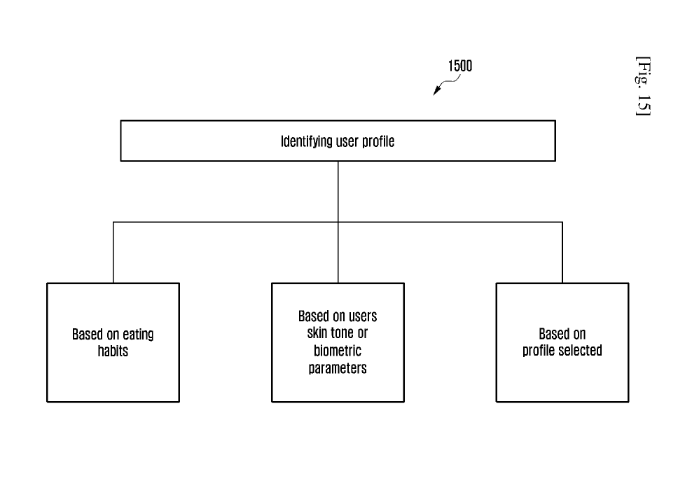

FIGS. 14a, 14b shows example screen shots of a user's device while providing recommendations, according to embodiments disclosed herein. The FIG. 14a depicts the screen shot of the electronic device 100 recommending the wastage of food last time. The FIG. 14b depicts the screen shot of the electronic device 100 remaining the user about his/her medicine intake.

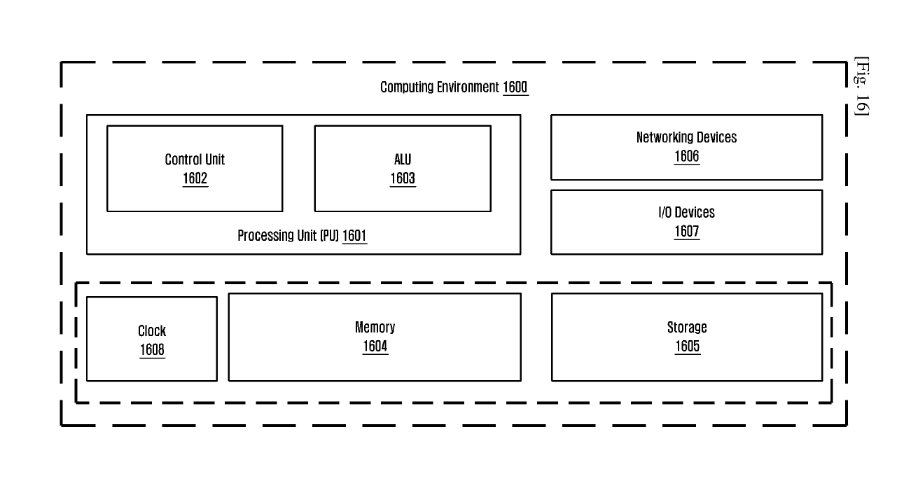

FIG. 15 shows different means of identifying a user profile, before capturing food consumption information, according to embodiments disclosed herein. The profile of a particular user can be identified based on a pattern of the food consumption action of the user. In an embodiment, the controlling member 105 is configured to detect the pattern of the user. For example, the pattern can be eating habits of the user. For example, the eating habits of the user can be detected based on acceleration, inclination, twisting, or rolling of the user's hand, wrist, or arm; acceleration or inclination of the user's lower arm or upper arm; bending of the user's shoulder, elbow, wrist, or finger joints; movement of the user's jaw, detection of chewing, swallowing, or other eating sounds by using one or more microphones. In an embodiment, the pattern can be user's skin tone, and biometric parameters. For example, different biometric sensors such as ultrasonic sensors, finger print sensors and the like can be used to capture the pattern of the user. Further, a match between the captured pattern and the stored historic patterns is determined and correct user profile is identified accordingly. The controlling member 105 can be configured to determine the match between the captured pattern and the stored historic patterns. Further, the profile is dynamically switched (if required), based on the match determined. The controlling member 105 can be configured to dynamically switch the profile associated with the user based on the match determined. In an embodiment, the user can manually select the profile in the electronic device 100. In an embodiment, the user can configure the profile information such as name, input means to trigger, personalized food preferences for different scenarios like breakfast, lunch, snacks and dinner and so on.

In an embodiment, the user may assign rankings to the food items relative to each other.

FIG. 16 illustrates a computing environment implementing the method and system for capturing food consumption information of a user, according to embodiments as disclosed herein. As depicted in the figure, the computing environment 1600 includes at least one processing unit 1601 that is equipped with a control unit 1602 and an Arithmetic Logic Unit (ALU) 1603, a memory 1604, a storage unit 1605, plurality of networking devices 1606 and a plurality Input output (I/O) devices 1607. The processing unit 1601 is responsible for processing the instructions of the algorithm. The processing unit 1601 receives commands from the control unit 1602 in order to perform its processing. Further, any logical and arithmetic operations involved in the execution of the instructions are computed with the help of the ALU 1603.

The algorithm comprising of instructions and codes required for the implementation are stored in either the memory unit 1604 or the storage 1605 or both. At the time of execution, the instructions may be fetched from the corresponding memory 1604 and/or storage 1605, and executed by the processing unit 1601.

In case of any hardware implementations various networking devices 1607 or external I/O devices 1606 may be connected to the computing environment to support the implementation through the networking unit and the I/O device unit. The embodiments disclosed herein can be implemented through at least one software program running on at least one hardware device and performing network management functions to control the network elements.

The embodiments disclosed herein can be implemented through at least one software program running on at least one hardware device and performing network management functions to control the elements. The elements shown in FIGS. 1a, 1b and 16 include blocks which can be at least one of a hardware device, or a combination of hardware device and software modules.

The embodiment disclosed herein specifies a method and system for capturing food consumption information of a user by automatically triggering one or more input means. The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the embodiments as described herein.

1. A method for capturing food consumption information of a subject, the method comprising:
detecting at least one food consumption action of said subject; and
if said at least one food consumption action is detected, automatically triggering at least one input means to capture information relating to said food being consumed by said subject.

2.-4. (canceled)

5. The method of claim 1, wherein said method further comprises:
if said at least one food consumption action is detected, automatically triggering at least one said imaging member to capture a plurality of pictures of said food being consumed by said subject;
correlating at least one said captured picture with at least one electronically-stored picture of at least one food item descriptive to identify said information related to said food being consumed by said subject; and
computing a food constituents data of said food being consumed by said subject based on said correlation.

6. The method of claim 1, wherein said method further comprises:
generating at least one recommendation relating to said at least one captured picture of said food based on said food constituents data; and
providing said at least one recommendation for a user corresponding to said electronic device and for at least one guardian of said user,
wherein said at least one recommendation is provided by using at least one of a text, voice, photo, video, light, vibration, and bell sound.

7.-11. (canceled)

12. The method of claim 1, wherein said method further comprises:
if said at least one food consumption action is detected, automatically triggering at least one said voice input means to capture voice data relating to said food being consumed by said subject;
correlating said voice data obtained with said at least one food item descriptive to identify said information related to said food being consumed by said subject; and
computing food constituents data of said food being consumed by said subject based on said correlation.

13.-23. (canceled)

24. The method of claim 1, wherein said method further comprises:
if said at least one food consumption action is detected, identifying said information related to said food being consumed by said subject from at least one of: said subject history information, and said subject personal preferences; and
computing food constituents data of said food being consumed by said subject based on said at least one food item descriptive.

25.-29. (canceled)

30. The method of claim 1, wherein said method further comprises:
identifying at least one food item within vicinity of said subject in a particular location; and
generating said at least one recommendation corresponding to said at least one food item for said subject,
wherein said at least food item is identified based on said food item descriptive and said recommendation based on preference of said subject.

31. (canceled)

32. The method of claim 1, wherein said method further comprises:
detecting a pattern of said at least one food consumption action of said subject;
determining a match between said pattern of said at least one food consumption action of said subject and a historic pattern of at least one food consumption action; and
dynamically switching a profile associated with said subject based on said match.

33. An electronic device for capturing food consumption information of a subject, the electronic device comprising:
an integrated circuit further comprising at least one processor;
at least one memory having a computer program code within said circuit,
wherein said at least one memory and said computer program code with said at least one processor cause said electronic device to:
detect at least one food consumption action of said subject, and
if said at least one food consumption action is detected, automatically trigger at least one input means to capture information relating to said food being consumed by said subject.

34.-36. (canceled)

37. The electronic device of claim 33, wherein said electronic device is further configured to:
if said at least one food consumption action is detected, automatically trigger at least one said imaging member to capture a plurality of pictures of said food being consumed by said subject;
correlate at least one said captured picture with at least one electronically-stored picture of at least one food item descriptive to identify said information related to said food being consumed by said subject; and
compute a food constituents data of said food being consumed by said subject based on said correlation.

38. The electronic device of claim 33, wherein said electronic device is further configured to generate at least one recommendation relating to said at least one captured picture of said food based on said food constituents data, and
wherein said at least one recommendation is provided by using at least one of a text, voice, photo, video, light, vibration, and bell sound.

39.-43. (canceled)

44. The electronic device of claim 33, wherein said electronic device is further configured to:
if said at least one food consumption action is detected, automatically trigger at least one said voice input means to capture voice data relating to said food being consumed by said subject;
correlate said voice data obtained with said at least one food item descriptive to identify said information related to said food being consumed by said subject; and
compute food constituents data of said food being consumed by said subject based on said correlation.

45.-55. (canceled)

56. The electronic device of claim 33, wherein said electronic device is further configured to:
if said at least one food consumption action is detected, identify said information related to said food being consumed by said subject from at least one of: said subject history information, and said subject personal preferences; and
compute food constituents data of said food being consumed by said subject based on said at least one food item descriptive.

57.-61. (canceled)

62. The electronic device of claim 33, wherein said electronic device identifies at least one food item within vicinity of said subject and generates a recommendation for said at least one food item.

63. (canceled)

64. The electronic device of claim 33, wherein said electronic device is further configured to:
detect a pattern of said at least one food consumption action of said subject;
determine a match between said pattern of said at least one food consumption action of said subject and a historic pattern of at least one food consumption action; and
dynamically switch a profile associated with said subject based on said match.

65.-96. (canceled)

97. A method for operating an electronic device, the method comprising:
detecting a movement pattern of said electronic device by using a first sensor;
identifying whether said movement pattern corresponds to a predetermined pattern; and
controlling a second sensor according to an identification result.

98. The method of claim 97, wherein said method further comprises:
detecting at least one of a user's heart rate, sound in surroundings of said electronic device, and object in surroundings of said electronic device

99. The method of claim 98, wherein said controlling a second sensor is performed in a method of controlling to a power to said second sensor if said movement pattern is said predetermined pattern.

100. An electronic device comprising:
a first sensor configured to detect a movement of said electronic device;
a second sensor configured to detect at least one of a user's heart rate corresponding to said electronic device, sound in surroundings of said electronic device, and subject in surroundings of said electronic device; and
a processor configured to identify whether said movement pattern corresponds to a predetermined pattern, and to determine operation of said second sensor based on an identification result.

101. The electronic device of claim 100, wherein said predetermined pattern comprises a movement pattern corresponding to at least one food consumption action.

102. The electronic device of claim 100, wherein said processor controls said second sensor in a method of controlling to supply a power to said second sensor, if said movement pattern is said predetermined pattern.
